(19) United States
(12) Patent Application Publication
(10) Pub. No.: US 2007/0124542 A1
(43) Pub. Date: May 31, 2007

(54) Method and system to control write caches to reduce risk of data loss

(75) Inventor: Adriaan van de Ven, Boekel (NL)

Correspondence Address: MH2 TECHNOLOGY LAW GROUP, 1951 KIDWELL DRIVE, SUITE 550, TYSONS CORNER, VA, 22182, US

(73) Assignee: Red Hat, Inc.

(21) Appl. No.: 11/289,399

(22) Filed: Nov. 30, 2005

(51) Int. Cl. G06F 13/00

(52) U.S. Cl. 711/143

(57) ABSTRACT

Embodiments of the present invention provide for controlling the write back caches in a computer system. In particular, when an event, such as a power failure or component failure, is detected, write back caching in both the computer system's memory and in the storage device are deactivated. In addition, one or both of the write back caches may be flushed to the storage medium.

### DESCRIPTION OF THE INVENTION

1. Field of the Invention

The present invention relates generally to controlling write caches. In particular, the present invention relates generally to controlling one or more write caches of a computer system to prevent the loss of data.

2. Background of the Invention

Write back caches are commonly implemented on computer systems to enhance performance. When data is being written to a storage medium, such as a hard disk drive, a write back cache may be used to store the data that is being written. This allows data to be accumulated and preserve wear and tear on the mechanical components of the hard drive. In addition, the write back cache may be used as a buffer to allow quick access to data that has been recently stored. Write back caches are used frequently in operating systems, such as the Windows operating system, UNIX operating systems, and LINUX operating systems. With write back caching turned on, the processor or operating system of a computer system is signaled that a data write is completed more quickly than if the had to wait until the data was completely transferred to the disk media.

Hard disk drives may also include their own physical memory to serve as a write back cache. For example, ATA drives, in particular, rely on write back caches to make up for the slower performance due to slower seek-time and speed of their disk drum in comparison to other types of drives counterparts. Some RAID controllers may also implement write cache on the controllers to enhance the overall performance of the system.

Unfortunately, in the event of a failure (such as power failure, hardware failure, etc.), data corruption may happen if the data on the write cache (in either the memory or the hard disk drive) has not been written out to the disk media. Conventionally, many systems use write through algorithms to maintain cache coherency and to prevent the loss data held in the cache due to the accidental or intentional power loss. The write through caching operates such that every time a change of data occurs in the cache, it manages to operate the hard disk drive to write the changes in the hard disk.

However, such algorithms are still prone to data loss in the event of a failure between cache flushes. In addition, although the operating system may control the write back cache in memory, the write back cache in the storage device may still make the computer system vulnerable to data loss. In order to avoid this problem, write back caching may be turned off at various times in both the memory and the storage device. Unfortunately, this will cause the system's performance to degrade. In addition, wear and tear on the components of the storage device will increase substantially.

Accordingly, it would be desirable to provide methods and system for controlling the write back caches in a computer system in order to prevent data loss.

### SUMMARY OF THE INVENTION

In accordance with one feature of the invention, a method of controlling write caching in a computer system is provided. Upon receiving an interrupt that indicates a potential loss of data, it is determined whether data is contained within a first write back cache in memory of the computer system and within a second write back cache in a storage device coupled to the computer system. Data contained within the first and second write back caches is then written onto the storage medium in the storage device in response to the interrupt.

Additional features of the present invention will be set forth in part in the description which follows, and in part will be obvious from the description, or may be learned by practice of the invention. It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments of the invention and together with the description, serve to explain the principles of the invention. In the figures:

FIG. 1 illustrates a computer system that is consistent with embodiments of the present invention;

FIG. 2 illustrates a software architecture of the computer system that is in accordance with embodiments of the present invention; and

FIG. 3 illustrates an exemplary process flow for controlling write back caches of a computer system.

### DESCRIPTION OF THE EMBODIMENTS

Embodiments of the present invention provide for controlling the write back caches in a computer system. In particular, when an event, such as a power failure or component failure, is detected, write back caching in both the computer system's memory and in the storage device are deactivated. In addition, one or both of the write back caches may be flushed to the storage medium.

Reference will now be made in detail to exemplary embodiments of the invention, which are illustrated in the accompanying drawings. Wherever possible, the same reference numbers will be used throughout the drawings to refer to the same or like parts.

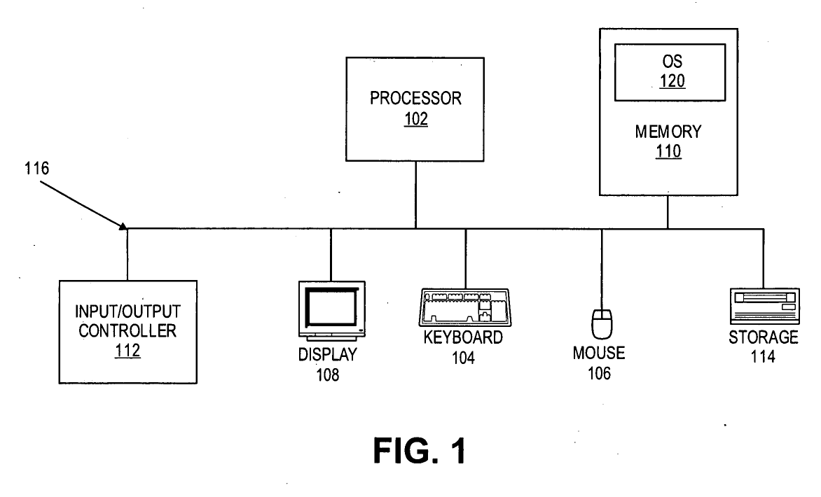

FIG. 1 illustrates a computer system 100 that is consistent with embodiments of the present invention. In general, embodiments of the present invention may be implemented in various computer systems, such as a personal computer, server, workstation, and the like. However, for purposes of explanation, system 100 is shown as a general purpose computer that is well known to those skilled in the art. Examples of the components that may be included in system 100 will now be described.

As shown, computer system 100 may include a central processor 102, a keyboard 104, a pointing device 106 (e.g., mouse, or the like), a display 108, a main memory 110, an input/output controller 112, and a storage device 114. Processor 102 may further include a cache memory 116 for storing frequently accessed information. Cache 16 may be an “on-chip” cache or external cache.

System 100 may also be provided with additional input/output devices, such as a printer (not shown). The various components of the system 100 communicate through a system bus 118 or similar architecture. In addition, computer system 100 may include an operating system (OS) 120 that resides in memory 110 during operation.

Main memory 110 may also serve as a primary storage area of computer system 100 and hold data that are actively being used by applications and processes running on processor 102. Memory 110 may be implemented as a random access memory or other form of memory, which are well known to those skilled in the art.

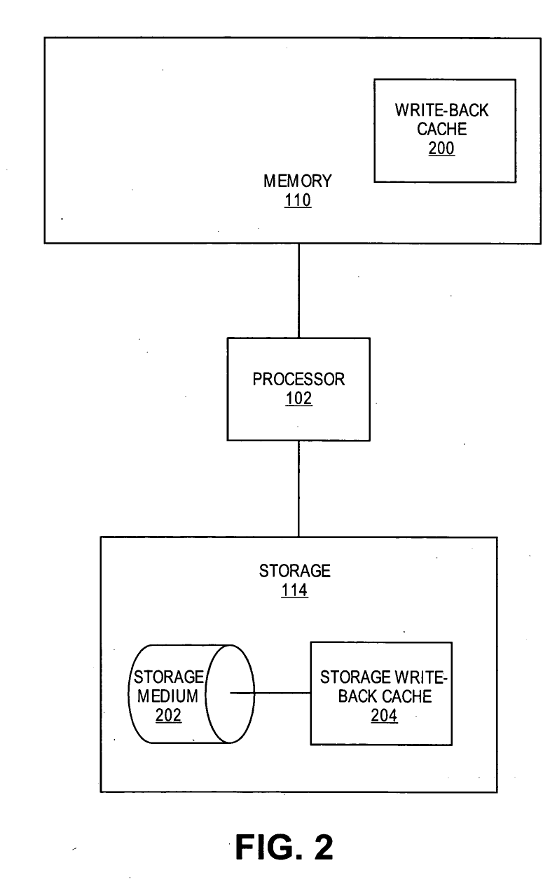

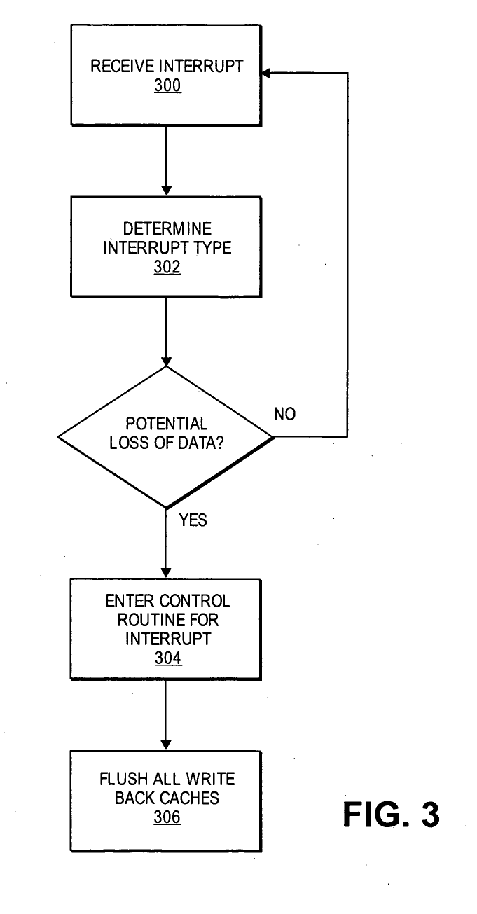

FIG. 2 illustrates write back caches that may be used in computer system 100. As shown, a first write back cache 200 may be implemented in physical memory 110. Write back cache 200 may generally be under the control of processor 102 and OS 120. The general algorithms of writing to write back cache 200 are well known to those skilled in the art. Storage device 114 may include a storage medium 202, such as a magnetic medium, or the like, and may also include its own storage write back cache 204. As will be explained below with reference to FIG. 3, in some embodiments, write back caches 200 and 204 are controlled in conjunction to performs read buffering and write buffering between the hard disk drive and memory 110.

Processor 102 and OS 120 control the write buffering operations of both the write back caches 200 and 204 using techniques according to the present invention. Generally, processor 102 and OS 120 allow write back caches 200 and 204 to operate such that once data in the main memory 110 has changed; the data is held in the cache and the data changes may not be written in the hard disk. In addition, if requested data cannot be found in either caches 200 or 204, then processor 102 and OS 120 may command that the data held in either of these caches be written (or flushed) to storage medium 202.

Processor 102 may also be configured to receive various status signals, such as status signal 206. For example, systems management interrupt (“SMI”) signals are well known to those skilled in the art. These signals may be generated by the various components of computer system 100. For example, an SMI signal may be generated in response to various events, such as a system power failure, a component failure, termination of a program, or reboot. Usually, an SMI is given the highest priority among all of interrupts in computer system 100. Upon receiving an SMI, OS 120 may then enter a processing routine for the event indicated by the SMI. In some embodiments, OS 120 is configured to control both write back caches 200 and 204 in response to an SMI and take various actions to minimize the risk of data loss.

For example, computer system 100 may comprise a power supply or battery (not shown). Processor 102 may monitor system bus 116 and measure power level data. If a power failure or drop is detected, processor 102 may receive an SMI and configure both write back caches 200 and 204 to write of the data stored to storage medium 202.

A method controlling write back caches 200 and 204 will now be described in detail with reference to FIG. 3. In stage 300, processor 102 receives an interrupt that indicates a potential loss of data. As noted, such an interrupt may relate to a power failure, component failure, low battery voltage, and the like.

In stage 302, processor 102 determines what kind of interrupt was received and proceeds to the corresponding control steps provided from OS 120. If the invoked interrupt indicates a potential loss of data, then processing proceeds to stage 304. If the invoked interrupt does not indicate a potential loss of data, then operations of write back caches 200 and 204 may continue and processing may loop back to stage 300.

In stage 304, processor 102 has detected a potential loss of data and enters the appropriate control routine provided by OS 120. For example, various control routines may relate to which of write back caches 200 and 204 are flushed. In addition, the control routines may indicate whether write back caches 200 and 204 are flushed in a particular order or simultaneously. Such a routine may be useful in preserving data ordering. Processing may then flow to stage 306.

In stage 306, processor 102 flushes write back caches 200 and 204 such that their data is written to storage medium 202. Processor 102 may then discontinue using write back cache 200. In addition, processor 102 may also command storage device 114 to discontinue using write back cache 204.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of controlling write caching in a computer system, said method comprising:
receiving an interrupt that indicates a potential loss of data; and
determining whether data is contained within a first write back cache in memory of the computer system and within a second write back cache in a storage device coupled to the computer system; and
writing data contained within the first and second write back caches onto a storage medium in the storage device in response to the interrupt.

2. The method of claim 1, wherein receiving the interrupt indicates a power failure in the computer system.

3. The method of claim 1, wherein receiving the interrupt indicates a reboot of the computer system.

4. The method of claim 1, wherein receiving the interrupt indicates a termination of program running on the computer system.

5. The method of claim 1, wherein writing data contained within the first and second write back caches comprises:
determining an order of data contained with the first and second write back caches; and
writing data contained within all write back caches based on the order of data.

6. The method of claim 1, wherein writing data contained within the first and second write back caches comprises:
writing data from the first write back cache to the storage medium; and
writing data from the second write back cache after the data from the first write back cache has been written to the storage medium.

7. The method of claim 1, wherein writing data contained within the first and second write back caches comprises:
writing data from the second write back cache to the storage medium; and
writing data from the first write back cache after the data from the second write back cache has been written to the storage medium.

8. A computer readable medium containing computer executable instructions for performing the method of claim 1.

9. An apparatus configured to perform the method of claim 1.
